(19) United States
(12) Patent Application Publication
(10) Pub. No.: US 2026/0096583 A1
(43) Pub. Date: Apr. 9, 2026

(54) SWEETENER COMPOSITION, FOOD PRODUCT, METHOD FOR PRODUCING A GOOD PRODUCT AND USE OF SUPRAMOLECULAR ASSEMBLIES

(71) Applicant: LaJoie Oy, Helsinki (FI)

(72) Inventor: Nasib NASERI, Helsinki (FI)

(73) Assignee: LaJoie Oy, Helsinki (FI)

(21) Appl. No.: 19/112,390

(22) PCT Filed: Sep. 18, 2023
(86) PCT No.: PCT/FI2023/050529

§ 371 Date: Mar. 17, 2025

(30) Foreign Application Priority Data
Sep. 19, 2022 (FI) 20225811
Dec. 22, 2022 (FI) 20226152

(51) Int. Cl. A23L 27/30; A23G 9/34; A23L 2/60

(52) U.S. Cl. CPC A23L 27/34; A23G 9/34; A23L 2/60

(57) ABSTRACT

A food product comprising one or more foodstuff, an anti-crystallizing component and a sweetener component is disclosed, the sweetener component comprising sugar alcohol. A method for producing a food product, and the use of supramolecular assemblies and a sweetener composition, are also disclosed.

### FIELD OF THE INVENTION

The present invention relates to a sweetener composition and more particularly to a sweetener composition according to preamble of claim 1.

The present invention further relates to a food product and more particularly to a food product according to preamble of claim 4.

The present invention further relates to a method for producing a food product and more particularly to a method for producing a food product according to preamble of claim 11.

The present invention further relates to a use of supramolecular assemblies and more particularly to a use of supramolecular assemblies according to preamble of claim 14.

### BACKGROUND OF THE INVENTION

Obesity is a medical condition, sometimes considered a disease in which abnormal or excess body fat has accumulated to such an extent that it may have a negative effect on health. Excess appetite for palatable, high-calorie food comprising sugar, is one of the primary factor driving obesity worldwide, likely because of imbalances in neurotransmitters affecting the drive to eat. Therefore, sugar should be replaced with a low calorie sweetener.

Many artificial sweeteners have drawbacks. A taste of stevia is bitter, but others think stevia tastes like menthol. Many do not like the taste of stevia.

Sugar alcohols (also called polyhydric alcohols, polyalcohols, alditols or glycitols) are organic compounds, typically derived from sugars, containing one hydroxyl group (—OH) attached to each carbon atom. They are white, water-soluble solids that can occur naturally or be produced industrially by hydrogenation of sugars. Since they contain multiple —OH groups, they are classified as polyols.

Sugar alcohols are used widely in the food industry as thickeners and sweeteners. In commercial foodstuffs, sugar alcohols are commonly used in place of table sugar (sucrose), typically in combination with high-intensity artificial sweeteners such as Saccharin, Aspartame, Acesulfame K, Sucralose, in order to offset their low sweetness.

Sugar alcohols, or polyols as a sugar substitute, they supply fewer calories (about a half to one-third fewer calories or even less) than sugar, and are converted to glucose slowly. Thus, sugar alcohols do not spike increases in blood glucose. Sugar alcohols has a drawback as many sugar alcohols which have a high relative sweetness cause an unpleasant cooling effect when a food product comprises a crystals of the sugar alcohol. For instance, erythritol having up to 80% relative sweetness, xylitol having up to 100% relative sweetness and maltitol having up to 90% relative sweetness. In the context of this application relative sweetness is compared to the sweetness of sucrose such that the sweetness of sucrose is 100%. Solubility of sugar alcohols decrease in lower temperatures. The unpleasant cooling effect of sugar alcohols limit using those in food products. Furthermore, several different sugar alcohols in the same food product may cause problems in digestion.

A preservative is a substance or a chemical that is added to products such as food products and beverages to prevent decomposition by microbial growth or by undesirable chemical changes.

Researchers have reported that both high-intensity artificial sweeteners and artificial preservatives can cause hypersensitivity, allergy, asthma, hyperactivity, neurological damage and cancer. Use of the preservative may be decreased or avoided by storing a food product in cold or frozen.

Accordingly, there is a need for a sweetener compound which may be used even in different kind of food products such that sweetener compound comprises natural low calorie sweetener component and at the same time the taste of the sweetener is pleasant. Furthermore, there is need for different kind of food products comprising natural low calorie sweetener component and at the same time the taste of the food product is pleasant. Furthermore, there is need for a beverage comprising natural low calorie sweetener component and at the same time the taste of the beverage is pleasant.

### BRIEF DESCRIPTION OF THE INVENTION

An object of the present invention is to provide a sweetener composition, such that the disadvantages of prior art are solved or at least alleviated.

The objects of the invention are achieved by a sweetener composition which is characterized by what is stated in the independent claim 1.

The objects of the invention are further achieved by a food product which is characterized by what is stated in the independent claim 4.

The objects of the invention are further achieved by a method for producing a food product which is characterized by what is stated in the independent claim 11.

The objects of the invention are further achieved by a use of supramolecular assemblies which is characterized by what is stated in the independent claim 14.

The preferred embodiments of the invention are disclosed in the dependent claims.

The invention is based on the idea of providing a sweetener composition, the sweetener composition comprises an anti-crystallizing component and a sweetener component, the sweetener component comprises sugar alcohol, and the sweetener composition being powder or gel or liquid.

A liquid sweetener composition preferably for some food product such as ketchup. The sweetener composition is easy to store and transport when it is powder. The gel is preferably for some food products such as ice creams.

In one embodiment, the anti-crystallizing component being liquid and the sweetener component being dissolved in the anti-crystallizing component.

In one embodiment, the anti-crystallizing component comprises any combination of following: an emulsifier, an ionic compound, a surfactant, a precursor of surfactant and a precursor of ionic compound.

In an alternative embodiment, the anti-crystallizing component comprises any combination of following: an emulsifier, a surfactant, a precursor of surfactant and a precursor of surfactant.

In another alternative embodiment, the anti-crystallizing component comprises an ionic compound.

In a further alternative embodiment, the anti-crystallizing component comprises amphiphilic molecules or a precursor of amphiphilic molecules; or

In a yet further alternative embodiment, the anti-crystallizing component comprises Sodium bicarbonate.

In another further alternative embodiment, the anti-crystallizing component consists of Sodium bicarbonate and acid molecules.

In a yet another further alternative embodiment, the anti-crystallizing component comprises Sodium bicarbonate and acid molecules.

In a yet another further alternative embodiment, the anti-crystallizing component comprises any combination of following: Sodium salt, Sodium acetate and Sodium bicarbonate and acid molecules.

In another further alternative embodiment, the anti-crystallizing component comprises more than 95 wt-% Sodium bicarbonate based on the total weight of the anti-crystallizing component.

The anti-crystallizing component may comprise up to 5 wt-% binder and impurities.

Sodium bicarbonate is a white solid that is crystalline, but often appears as a fine powder. Sodium bicarbonate is nontoxic. Sodium bicarbonate is a chemical compound with the formula NaHCO₃. It is composed of a sodium cation (Na+) and a bicarbonate anion (HCO3−). Sodium bicarbonate is not a surfactant but Sodium salts are formed when Sodium bicarbonate reacts with acids. These salts are natural surfactants and provide surfactant action. Therefore, Sodium bicarbonate may be used to form supramolecular assemblies which reduced forming crystals of sugar alcohols. Furthermore, Sodium carbonate may be used with clear liquids.

Lecithin is a generic term to designate any group of yellow-brownish fatty substances occurring in animal and plant tissues which are amphiphilic—they attract both water and fatty substances (and so are both hydrophilic and lipophilic). Therefore, Lecithin may be used to form micelles which decrease an amount of crystals of sugar alcohols in a liquid product. Emulsifiers are food additive molecules that act as a stabilizer for emulsions. Surfactants are chemical compounds that decrease the surface tension between two liquids, between a gas and a liquid, or interfacial tension between a liquid and a solid.

In one embodiment, the sweetener component comprises xylitol or erythritol.

Erythritol has had a history of safe use as a sweetener and flavor-enhancer in food and beverage products, and is approved for use by government regulatory agencies of many countries. It has a caloric value of 0.2 calories per gram. Erythritol has no effect on blood sugar or blood insulin levels and therefore may become an effective substitute for sugar for diabetics. Erythritol occurs naturally in some fruit and fermented foods.

Xylitol is used as a sugar substitute in such manufactured products as drugs, dietary supplements, confections, toothpaste, and chewing gum, but is not a common household sweetener. Xylitol has negligible effects on blood sugar because it is metabolized independently of insulin. Humans absorb xylitol more slowly than sucrose, and xylitol supplies 40% fewer calories than an equal mass of sucrose. It is approved as a food additive in the United States and elsewhere.

In an alternative embodiment, the sweetener component comprises more than 95 wt-% xylitol based on the total weight of the sweetener component.

This provides a sweetener component having a sweet taste but sometimes the sweetener component may comprise up to 5 wt-% binder and impurities.

In another alternative embodiment, the sweetener component comprises more than 95 wt-% erythritol based on the total weight of the sweetener component.

This provides a sweetener component having a sweet taste but sometimes the sweetener component may comprise up to 5 wt-% binder and impurities.

In a yet alternative embodiment, the sweetener component consists of xylitol or erythritol.

In a further alternative embodiment, the sweetener component consists of xylitol.

In a yet further alternative embodiment, the sweetener component consists of erythritol.

In a yet further alternative embodiment, the sweetener component comprises xylitol and erythritol.

The present invention further relates to a food product. The food product comprises one or more foodstuff, an anti-crystallizing component and a sweetener component. The sweetener component comprises sugar alcohol.

This is food product which comprises low amount calories and sweet taste is achieved with natural sweetener.

In one embodiment, the food product being a liquid food product or a paste food product or a solid food product.

The present is suitable for various products.

In an alternative embodiment, the food product being a liquid food product or a paste food product.

The present is preferably suitable for products comprising liquid.

In another alternative embodiment, the food product being a beverage.

The present is preferably suitable for products comprising liquid such as beverage.

In a yet another alternative embodiment, the food product being a beverage, and the food product comprises Carbon dioxide.

The present is preferably suitable for products comprising liquid such as soft drink.

In a yet further alternative embodiment, the food product being an ice cream.

The present is preferably suitable for products comprising liquid such as ice cream.

In one embodiment, the food product comprises one or more supramolecular assemblies.

In an alternative embodiment, the food product comprises one or more supramolecular assemblies composed from an emulsifier, a surfactant or an ionic compound.

In another alternative embodiment, the food product comprises one or more clusters, wherein each cluster has a hydrophilic region and a hydrophobic region.

In a yet another alternative embodiment, the food product comprises one or more clusters, wherein each cluster has a hydrophilic region and a hydrophobic region, at least one of the one or more clusters being a micelle or at least one of the one or more clusters being a liposome.

In a yet another further alternative embodiment, the food product comprises one or more clusters, at least one of the one or more clusters being a micelle or at least one of the one or more clusters being a liposome.

In a yet further alternative embodiment, the food product comprises one or more molecules of the sweetener component surrounded by supramolecular assemblies.

Typically the cooling effect of sugar alcohols prevent creation of supramolecular assemblies.

In one embodiment, the food product comprises a liquid component, and a concentration of the sweetener component in the liquid component exceeding the value of solubility at equilibrium at a temperature of 20° C. by 5 wt-% or more, or at a temperature of 20° C. by 10 wt-% or more, or at a temperature of 20° C. by 20 wt-% or more, or at a temperature of 20° C. by 5-50 wt-%, or at a temperature of 20° C. by 5-20 wt-%, or at a temperature of 20° C. by 5-70 wt-%, or at a temperature of 4° C. by 5 wt-% or more, or at a temperature of 4° C. by 10 wt-% or more, or at a temperature of 4° C. by 20 wt-% or more, or at a temperature of 4° C. by 5-50 wt-%, or at a temperature of 4° C. by 5-20 wt-%, or at a temperature of 4° C. by 5-70 wt-%, or at a temperature of −18° C. by 5 wt-% or more, or at a temperature of −18° C. by 10 wt-% or more, or at a temperature of −18° C. by 20 wt-% or more, or at a temperature of −18° C. by 5-50 wt-%, or at a temperature of −18° C. by 5-20 wt-%, or at a temperature of −18° C. by 5-70 wt-%, based on weight of the sweetener component at equilibrium.

In an alternative embodiment, the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component.

In another alternative embodiment, the food product comprises a liquid component, and a concentration of the sweetener component in the liquid component exceeding the value of solubility at equilibrium at a temperature of 20°C. by 5 wt-% or more, or at a temperature of 20° C. by 10 wt-% or more, or at a temperature of 20° C. by 20 wt-% or more, or at a temperature of 20° C. by 5-50 wt-%, or at a temperature of 20° C. by 5-20 wt-%, or at a temperature of 20° C. by 5-70 wt-%, or at a temperature of 4° C. by 5 wt-% or more, or at a temperature of 4° C. by 10 wt-% or more, or at a temperature of 4° C. by 20 wt-% or more, or at a temperature of 4° C. by 5-50 wt-%, or at a temperature of 4° C. by 5-20 wt-%, or at a temperature of 4° C. by 5-70 wt-%, or at a temperature of −18° C. by 5 wt-% or more, or at a temperature of −18° C. by 10 wt-% or more, or at a temperature of −18° C. by 20 wt-% or more, or at a temperature of −18° C. by 5-50 wt-%, or at a temperature of −18° C. by 5-20 wt-%, or at a temperature of −18° C. by 5-70 wt-%, based on weight of the sweetener component at equilibrium, and the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component.

Benefits of these embodiments are found out based on the examples.

In one embodiment, an amount of the anti-crystallizing component being between 0.01 to 0.7 times or between 0.03 to 0.3 times or between 0.1 to 0.3 times an amount of the sweetener component based on weight of the sweetener composition and the anti-crystallizing component.

Benefits of these embodiments are found out based on the examples.

In one embodiment, the one or more foodstuff comprises any combination of following: a liquid component comprising water, ethanol, one or more components produced from grain, one or more components produced from milk, one or more components produced from egg, a component comprising fruit, a component comprising vegetable, a component comprising berry and one or more component comprising flavouring agent.

In an alternative embodiment, the one or more foodstuff comprises any combination of following: water, ethanol, one or more components produced from grain, a component comprising fruit, a component comprising berry and one or more component comprising flavouring agent.

In another alternative embodiment, the one or more foodstuff comprises any combination of following: water, and one or more component comprising flavouring agent.

In a yet another alternative embodiment, the one or more foodstuff comprises any combination of following: water, and one or more component comprising flavouring agent, and at least one of the one or more food stuff being acid.

In one embodiment, the food product comprises any combination of following: any above disclosed embodiment of a sweetener component according, any above disclosed embodiment of an anti-crystallizing component, and any above disclosed embodiment of a sweetener composition.

The present invention further relates to a method for producing a food product. The method comprises:
providing one or more food stuff, a sweetener component and an anti-crystallization component, the sweetener component comprises sugar alcohol; and
forming the food product from the one or more food stuff, the sweetener component and the anti-crystallization component.

In one embodiment, the method comprises forming one or more supramolecular assemblies from the anti-crystallization component.

In an alternative embodiment, the method being carried out with an apparatus comprising a warming device, and the method comprises warming with the warming device any combination of the following: the sweetener component, the anti-crystallization component, the food product, the one or more food stuff and the one or more of the food stuff comprising a liquid.

In another alternative embodiment, the method being carried out with an apparatus comprising a warming device and a mixing device, the method comprises warming with the warming device any combination of the following: the sweetener component, the anti-crystallization component, the food product, the one or more food stuff and the one or more of the food stuff comprising a liquid, and mixing with the mixing device any combination of the following: the sweetener component, the anti-crystallization component, the food product, the one or more food stuff and the one or more of the food stuff comprising a liquid.

In a further embodiment, the method being carried out with an apparatus comprising a warming device and a mixing device, the method comprises warming with the warming device any combination of the following: the sweetener component, the anti-crystallization component, the food product, the one or more food stuff and the one or more of the food stuff comprising a liquid, and mixing with the mixing device any combination of the following: the sweetener component, the anti-crystallization component, the food product, the one or more food stuff and the one or more of the food stuff comprising a liquid, and increasing a temperature of liquid comprising any combination of following: the anti-crystallization component, the sweetener component and the food product.

In a further alternative embodiment, the method being carried out with an apparatus comprising a warming device and a mixing device, and at least one of the one or more food stuff comprises liquid, and the method comprises mixing at least a portion of the one or more food stuff comprises liquid and the sweetener component together with the mixing device and after mixing one or more food stuff comprises liquid and the sweetener component together, the method comprises a step of warming the mixed liquid and the sweetener component with the warming device.

In a yet further alternative embodiment, the method being carried out with an apparatus comprising a warming device and a mixing device, and at least one of the one or more food stuff comprises water, and the method comprises mixing at least a portion of the one or more food stuff comprises water and the sweetener component together with the mixing device and after mixing one or more food stuff comprises water and the sweetener component together the method comprises a step of warming the mixed water and the sweetener component with the warming device.

In another yet further alternative embodiment, the method being carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid sweetener composition or the liquid anti-crystallization composition with the warming device and, mixing the liquid anti-crystallization composition and the liquid sweetener composition together with the mixing device.

5-50% of the one or more food stuff comprising water provides a liquid so that formation of supramolecular assemblies is promoted.

In a yet another further alternative embodiment, the method being carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid sweetener composition with the warming device and, mixing the liquid anti-crystallization composition and the liquid sweetener composition together with the mixing device.

In a still another further alternative embodiment, the method being carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid anti-crystallization composition with the warming device and, mixing the liquid anti-crystallization composition and the liquid sweetener composition together with the mixing device.

In a still yet another alternative embodiment, the method being carried out with an apparatus comprising a warming device and a mixing device, one or more food stuff comprises water, and the method comprises a steps of mixing the one or more food stuff comprising water, the anti-crystallization component and the sweetener component together for providing a liquid composition, warming the liquid composition comprising the one or more food stuff comprising water, the anti-crystallization component and the sweetener component with the warming device.

Preferably, the one or more supramolecular assemblies comprises a plurality of supramolecular assemblies.

Warming compensates Sugar alcohol cooling effect which prevents formation of supramolecular assemblies.

In one embodiment, the food product produced by the method comprises any combination of following: any above disclosed embodiment of a sweetener component according, any above disclosed embodiment of an anti-crystallizing component, and any above disclosed embodiment of a sweetener composition.

In one embodiment, the sweetener component being any above embodiment of a sweetener component, the anti-crystallizing component being any above embodiment of an anti-crystallizing component and the food product being any above embodiment of a food product.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises a component comprising water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: clusters of the surfactant molecules of the anti-crystallizing component or clusters of surfactant molecules comprising the precursor of surfactant molecules.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: supramolecular assemblies of the molecules comprising the surfactant molecules of the anti-crystallizing component or supramolecular assemblies of surfactant molecules comprising the precursor of surfactant.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The method further comprises forming the food product from the one or more food stuff, the sweetener component and the anti-crystallization component; and the food product comprises any combination of following: micelles of the molecules comprising the surfactant molecules of the anti-crystallizing component or micelles of surfactant molecules comprising the precursor of surfactant.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: micelles of the molecules comprising the surfactant molecules of the anti-crystallizing component or micelles of surfactant molecules comprising the precursor of surfactant. The step of forming the food product further comprises warming a temperature of the anti-crystallizing component and the water greater.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: micelles of the molecules comprising the surfactant molecules of the anti-crystallizing component or micelles of surfactant molecules comprising the precursor of surfactant. The food product being beverage.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: micelles of the molecules comprising the surfactant molecules of the anti-crystallizing component or micelles of surfactant molecules comprising the precursor of surfactant. The food product being ice cream.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: micelles of the molecules comprising the surfactant molecules of the anti-crystallizing component or micelles of surfactant molecules comprising the precursor of surfactant. The food product is beverage and the method further comprises providing Carbon Dioxide into the food product.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: micelles of the molecules comprising the surfactant molecules of the anti-crystallizing component or micelles of surfactant molecules comprising the precursor of surfactant. The food product is beverage and the method further comprises providing Carbon Dioxide into the food product. The step of forming the food product comprises being carried out in a system comprising a vessel.

In one embodiment, method for producing a food product comprises providing one or more food stuff, a sweetener component and an anti-crystallization component; and forming the food product from the one or more food stuff, the sweetener component and the anti-crystallization component. The sweetener component comprises Xylitol or Erythritol. The one or more food stuff comprises water and any combination of the following: a component comprising fruit, a component comprising berry and a flavouring agent. The anti-crystallizing component comprises surfactant molecules or a precursor of surfactant molecules. The method further comprises forming the food product from the one or more food stuff, the sweetener component and the anti-crystallization component; and the food product comprises any combination of following: micelles of the molecules comprising the surfactant molecules of the anti-crystallizing component or micelles of surfactant molecules comprising the precursor of surfactant. The food product is beverage and the method further comprises providing Carbon Dioxide into the food product. The step of forming the food product comprises being carried out in a system comprising a vessel. The sweetener component being any above disclosed embodiment of the sweetener component. The anti-crystallizing component being any above disclosed embodiment of the anti-crystallizing component. The food product being any above disclosed embodiment of the food product.

The present invention further based on an idea of use of supramolecular assemblies for reducing formation of sugar alcohol crystals in a food product, the food product comprises one or more food stuff and sugar alcohol.

In one embodiment, the food product comprises any above disclosed embodiment of sweetener composition, the food product comprises any above disclosed embodiment of an anti-crystallizing, and the food product being any above disclosed embodiment of a food product.

In one embodiment, the sugar alcohol in the water exceeding the value of solubility at equilibrium at a temperature of 20° C. or 4° C. or −18° C. by 5 wt-% or more.

In one embodiment, the sweetener component being any above disclosed embodiment of the sweetener component. The anti-crystallizing component being any above disclosed embodiment of the anti-crystallizing component. The food product being any above disclosed embodiment of the food product.

An advantage of the invention is that it provides a sweetener composition comprising sugar alcohol such that crystals of the sugar alcohol does not cause an unpleasant cooling effect. Furthermore, the sweetener composition may be used in frozen food product and thus, preservatives are not need or their amount may be decreased. Furthermore, the sweetener composition may be used in beverages and thus, sugar and artificial sweeteners are not need or their amount may be decreased. The invention also provides a food product is sweetened with sugar alcohol such that the food product may be frozen such that the sugar alcohol does not cause an unpleasant cooling effect. Furthermore, the invention provides a method for producing a food product comprising sweetener composition comprising sugar alcohol such that the sugar alcohol does not cause an unpleasant cooling effect.

### BRIEF DESCRIPTION OF THE DRAWINGS

The invention is described in detail by means of specific embodiments with reference to the enclosed drawings, in which

FIG. 1 shows steps of one embodiment of a process according to the present invention.

### DETAILED DESCRIPTION OF THE INVENTION

The present invention provides a sweetener composition. The sweetener composition comprises an anti-crystallizing component and a sweetener component. The sweetener component comprises sugar alcohol, and the sweetener composition being powder or gel or liquid.

In the context of this application, the sweetener composition being powder means that the sweetener composition comprises dry particles of the anti-crystallizing component and dry particles of the sweetener component.

In the context of this application, gel is a semi-solid that can have properties ranging from soft and weak to hard and tough. In the context of this application, liquid means that a physical state of the composition being liquid at a temperature of 4° C.

In the context of this application, crystals mean a result of the process of forming a crystalline structure from a fluid or from materials dissolved in a fluid.

Sugar alcohols (also called polyhydric alcohols, polyalcohols, alditols or glycitols) are organic compounds, typically derived from sugars, containing one hydroxyl group (—OH) attached to each carbon atom. They are white, water-soluble solids that can occur naturally or be produced industrially by hydrogenation of sugars. Since they contain multiple —OH groups, they are classified as polyols.

Preferably, the sweetener component comprises xylitol or erythritol.

In another preferred embodiment, the sweetener component consists of xylitol or erythritol

In another preferred embodiment, the sweetener component comprises more than 95 wt-% xylitol.

In another preferred embodiment, the sweetener component comprises more than 95 wt-% erythritol.

In another preferred embodiment, the sweetener component consists of xylitol.

### In Another Preferred Embodiment, the Sweetener Component Consists of erythritol.

In certain embodiments, the anti-crystallizing component comprises any combination of following: an emulsifier, an ionic compound, a surfactant, a precursor of surfactant and a precursor of ionic compound.

In certain embodiments, the anti-crystallizing component comprises any combination of following: an emulsifier, a surfactant, a precursor of surfactant and a precursor of surfactant.

The emulsifier may be any combination of following: gelatine, lecithin, mono and diglycerides, quillaja extract, Sodium Stearoyl Lactylate, cellulose gum, carboxy methyl cellulose, sucrose esters of fatty acids, Propylene Glycol Monostearate, Polyglycerol Polyricinoleate, carrageenan, xanthan, and gum karaya.

In certain embodiments, the anti-crystallizing component comprises an ionic compound.

In certain embodiments, the anti-crystallizing component comprises amphiphilic molecules or a precursor of amphiphilic molecules.

In certain embodiments, the anti-crystallizing component comprises Sodium bicarbonate.

In certain embodiments, the anti-crystallizing component consists of Sodium bicarbonate and acid molecules.

In certain embodiments, the anti-crystallizing component comprises Sodium bicarbonate and acid molecules.

In certain embodiments, the anti-crystallizing component comprises any combination of following: Sodium salt, Sodium acetate and Sodium bicarbonate and acid molecules.

The present invention further relates to a food product. The food product comprises one or more foodstuff, an anti-crystallizing component and a sweetener component. The sweetener component comprises sugar alcohol.

Surfactants are chemical compounds that decrease the surface tension between two liquids, between a gas and a liquid, or interfacial tension between a liquid and a solid. Surfactants may act as emulsifier.

An amphiphile is a chemical compound possessing both hydrophilic (water-loving, polar) and lipophilic (fat-loving) properties. Such a compound is called amphiphilic or amphipathic. Common amphiphilic substances are soaps, detergents, and lipoproteins. The phospholipid amphiphiles are the major structural component of cell membranes. The micelles they form in the aggregate are prolate. The lipophilic group is typically a large hydrocarbon moiety, such as a long chain of the form CH3(CH2)n, with n>4.

The hydrophilic group falls into one of the following categories:

### A) Charged Groups

Anionic. Examples, with the lipophilic part of the molecule represented by an R, are:
carboxylates: RCO2—;
sulfates: RSO4—;
sulfonates: RSO3—.
phosphates: The charged functionality in phospholipids.

Cationic. Examples:
ammoniums: RNH3+.

### B) Polar, Uncharged Groups

Examples are alcohols with large R groups, such as diacyl glycerol (DAG), and oligoethyleneglycols with long alkyl chains.

Often, amphiphilic species have several lipophilic parts, several hydrophilic parts, or several of both. Proteins and some block copolymers are such examples.

Amphiphilic compounds have lipophilic (typically hydrocarbon) structures and hydrophilic polar functional groups (either ionic or uncharged).

As a result of having both lipophilic and hydrophilic portions, some amphiphilic compounds may dissolve in water.

In one embodiment, the sweetener composition comprises a liquid component, a physical state of the liquid component being liquid at a temperature of 20° C. and a concentration of the sweetener component in the liquid component exceeding the value of solubility at equilibrium in the liquid component at a temperature of 20° C.

In context of this application, solubility is the ability of a substance, the solute, to form a solution with another substance, the solvent. Insolubility is the opposite property, the inability of the solute to form such a solution. The extent of the solubility of a substance in a specific solvent is generally measured as the concentration of the solute in a saturated solution, one in which no more solute can be dissolved. At this point, the two substances are said to be at the solubility equilibrium.

The present invention further relates to a food product. The food product comprises one or more foodstuff, an anti-crystallizing component and a sweetener component, and the sweetener component comprises sugar alcohol.

In certain embodiments, the food product being a liquid food product or a paste food product or a solid food product.

In certain embodiments, the food product being a liquid food product or a paste food product.

In certain embodiments, the food product being a beverage.

In certain embodiments, the food product being a beverage, and the food product comprises Carbon dioxide.

In certain embodiments, the food product being an ice cream.

In the context of this application, paste means a semi-liquid colloidal suspension. An example of paste food product is ketchup.

In certain embodiments, the food product comprises one or more supramolecular assemblies.

Preferably, the one or more supramolecular assemblies comprises a plurality of supramolecular assemblies.

In certain embodiments, the food product comprises one or more supramolecular assemblies composed from an emulsifier, a surfactant or an ionic compound.

In certain embodiments, the food product comprises one or more clusters, wherein each cluster has a hydrophilic region and a hydrophobic region. Preferably, the one or more clusters comprises a plurality of clusters.

In certain embodiments, the food product comprises one or more clusters, wherein each cluster has a hydrophilic region and a hydrophobic region, at least one of the one or more clusters being a micelle or at least one of the one or more clusters being a liposome.

In certain embodiments, the food product comprises one or more clusters, at least one of the one or more clusters being a micelle or at least one of the one or more clusters being a liposome; or

In certain embodiments, the food product comprises one or more molecules of the sweetener component surrounded by supramolecular assemblies.

In certain embodiments, the food product comprises one or more molecules of the sweetener component surrounded by supramolecular assemblies means that the food product comprises a plurality of molecules of the sweetener component surrounded by a plurality of supramolecular assemblies.

In certain embodiments, the food product comprises one or more molecules of the sweetener component surrounded by supramolecular assemblies means that the food product comprises a plurality of molecules of the sweetener component being inside supramolecular assemblies.

In certain embodiments, the food product comprises one or more molecules of the sweetener component surrounded by supramolecular assemblies means that the food product comprises a plurality of supramolecular assemblies around the molecules of the sweetener component.

A supramolecular assembly is a complex of molecules held together by noncovalent bonds. Colloids, biomolecular condensates, micelles, liposomes and biological membranes are examples of supramolecular assemblies.

An ionic compound is a chemical compound composed of ions held together by electrostatic forces termed ionic bonding. Thus, the ionic compound being a supramolecular assembly.

In certain embodiments, the food product comprises a liquid component, and a concentration of the sweetener component in the liquid component exceeding the value of solubility at equilibrium at a temperature of 20° C. by 5 wt-% or more, or at a temperature of 20° C. by 10 wt-% or more, or at a temperature of 20° C. by 20 wt-% or more, or at a temperature of 20° C. by 5-50 wt-%, or at a temperature of 20° C. by 5-20 wt-%, or at a temperature of 20° C. by 5-70 wt-%.

In certain embodiments, the food product comprises a liquid component, and a concentration of the sweetener component in the liquid component exceeding the value of solubility at equilibrium at a temperature of 4° C. by 5 wt-% or more, or at a temperature of 4° C. by 10 wt-% or more, or at a temperature of 4° C. by 20 wt-% or more, or at a temperature of 4° C. by 5-50 wt-%, or at a temperature of 4° C. by 5-20 wt-%, or at a temperature of 4° C. by 5-70 wt-%.

In certain embodiments, the food product comprises a liquid component, and a concentration of the sweetener component in the liquid component exceeding the value of solubility at equilibrium at a temperature of −18° C. by 5 wt-% or more, or at a temperature of −18° C. by 10 wt-% or more, or at a temperature of −18° C. by 20 wt-% or more, or at a temperature of −18° C. by 5-50 wt-%, or at a temperature of −18° C. by 5-20 wt-%, or at a temperature of −18° C. by 5-70 wt-%, based on weight of the sweetener component at equilibrium.

In certain embodiments, the food product comprises less than 1 wt-% or less than 0.5 wt-% or less than 0.1 wt-% or less than 0.01 wt-% or 0.5 wt-% 0.01 wt % or 1 wt-%-0.01 wt % crystal particles of sweetener component based on weight of the sweetener component.

In certain embodiments, the food product comprises a liquid component, and a concentration of the sweetener component in the liquid component exceeding the value of solubility at equilibrium at a temperature of 20° C. by 5 wt-% or more, or at a temperature of 20° C. by 10 wt-% or more, or at a temperature of 20° C. by 20 wt-% or more, or at a temperature of 20° C. by 5-50 wt-%, or at a temperature of 20° C. by 5-20 wt-%, or at a temperature of 20° C. by 5-70 wt-%, and the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component.

In certain embodiments, the food product comprises a liquid component, and a concentration of the sweetener component in the liquid component exceeding the value of solubility at equilibrium at a temperature of 4° C. by 5 wt-% or more, or at a temperature of 4° C. by 10 wt-% or more, or at a temperature of 4° C. by 20 wt-% or more, or at a temperature of 4° C. by 5-50 wt-%, or at a temperature of 4° C. by 5-20 wt-%, or at a temperature of 4° C. by 5-70 wt-%, and the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component.

In certain embodiments, the food product comprises a liquid component, and a concentration of the sweetener component in the liquid component exceeding the value of solubility at equilibrium at a temperature of −18° C. by 5 wt-% or more, or at a temperature of −18° C. by 10 wt-% or more, or at a temperature of −18° C. by 20 wt-% or more, or at a temperature of −18° C. by 5-50 wt-%, or at a temperature of −18° C. by 5-20 wt-%, or at a temperature of −18° C. by 5-70 wt-%, based on weight of the sweetener component at equilibrium, and the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component.

A solubility equilibrium exists when a chemical compound in the solid state is in chemical equilibrium with a solution containing the compound. This type of equilibrium is an example of dynamic equilibrium in that some individual molecules migrate between the solid and solution phases such that the rates of dissolution and precipitation are equal to one another. When equilibrium is established and the solid has not all dissolved, the solution is said to be saturated

In certain embodiments, an amount of the anti-crystallizing component being between 0.01 to 0.7 times or between 0.03 to 0.3 times or between 0.1 to 0.3 times an amount of the sweetener component based on weight of the sweetener composition and the anti-crystallizing component.

In certain embodiments, the one or more foodstuff comprises any combination of following: a liquid component comprising water, ethanol, one or more components produced from grain, one or more components produced from milk, one or more components produced from egg, a component comprising fruit, a component comprising vegetable, a component comprising berry and one or more component comprising flavouring agent.

In certain embodiments, the one or more foodstuff comprises any combination of following: water, ethanol, one or more components produced from grain, a component comprising fruit, a component comprising berry and one or more component comprising flavouring agent.

In certain embodiments, the one or more foodstuff comprises any combination of following: water, and one or more component comprising flavouring agent.

In certain embodiments, the one or more foodstuff comprises any combination of following: water, and one or more component comprising flavouring agent, and at least one of the one or more food stuff being acid.

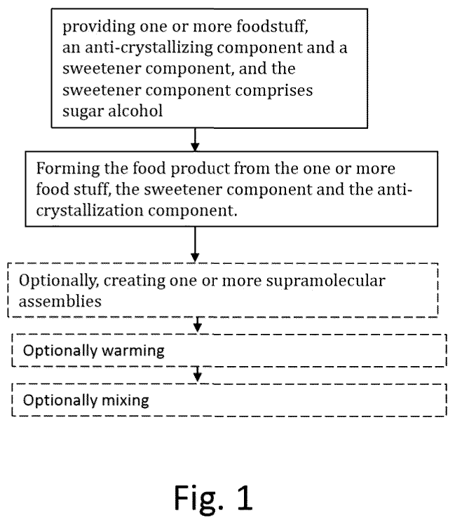

FIG. 1 shows steps of one embodiment of a process according to the present invention.

The method comprises:
providing one or more food stuff, a sweetener component and an anti-crystallization component, the sweetener component comprises sugar alcohol; and
forming the food product from the one or more food stuff, the sweetener component and the anti-crystallization component.

In certain embodiments, the method comprises forming one or more supramolecular assemblies from the anti-crystallization component.

In certain embodiments, the method being carried out with an apparatus comprising a warming device, and the method comprises warming with the warming device any combination of the following: the sweetener component, the anti-crystallization component, the food product, the one or more food stuff and the one or more of the food stuff comprising a liquid.

In certain embodiments, the method being carried out with an apparatus comprising a warming device and a mixing device, the method comprises warming with the warming device any combination of the following: the sweetener component, the anti-crystallization component, the food product, the one or more food stuff and the one or more of the food stuff comprising a liquid, and mixing with the mixing device any combination of the following: the sweetener component, the anti-crystallization component, the food product, the one or more food stuff and the one or more of the food stuff comprising a liquid.

In certain embodiments, the method being carried out with an apparatus comprising a warming device and a mixing device, the method comprises warming with the warming device any combination of the following: the sweetener component, the anti-crystallization component, the food product, the one or more food stuff and the one or more of the food stuff comprising a liquid, and mixing with the mixing device any combination of the following: the sweetener component, the anti-crystallization component, the food product, the one or more food stuff and the one or more of the food stuff comprising a liquid, and increasing a temperature of liquid comprising any combination of following: the anti-crystallization component, the sweetener component and the food product.

In certain embodiments, the method being carried out with an apparatus comprising a warming device and a mixing device, and at least one of the one or more food stuff comprises liquid, and the method comprises mixing at least a portion of the one or more food stuff comprises liquid and the sweetener component together with the mixing device and after mixing one or more food stuff comprises liquid and the sweetener component together, the method comprises a step of warming the mixed liquid and the sweetener component with the warming device.

In certain embodiments, the method being carried out with an apparatus comprising a warming device and a mixing device, and at least one of the one or more food stuff comprises water, and the method comprises mixing at least a portion of the one or more food stuff comprises water and the sweetener component together with the mixing device and after mixing one or more food stuff comprises water and the sweetener component together the method comprises a step of warming the mixed water and the sweetener component with the warming device.

In certain embodiments, the method being carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid sweetener composition or the liquid anti-crystallization composition with the warming device and, mixing the liquid anti-crystallization composition and the liquid sweetener composition together with the mixing device.

In certain embodiments, the method being carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid sweetener composition with the warming device and, mixing the liquid anti-crystallization composition and the liquid sweetener composition together with the mixing device.

In certain embodiments, the method being carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid anti-crystallization composition with the warming device and, mixing the liquid anti-crystallization composition and the liquid sweetener composition together with the mixing device.

In certain embodiments, the method being carried out with an apparatus comprising a warming device and a mixing device, one or more food stuff comprises water, and the method comprises a steps of mixing the one or more food stuff comprising water, the anti-crystallization component and the sweetener component together for providing a liquid composition, warming the liquid composition comprising the one or more food stuff comprising water, the anti-crystallization component and the sweetener component with the warming device.

Preferably, the one or more supramolecular assemblies comprises a plurality of supramolecular assemblies.

In certain embodiments, the anti-crystallization component and the one or more food stuff comprising water are mixed together so that an anti-crystallization gel is provided. The temperature of the anti-crystallization gel is maintained. The method comprises mixing the anti-crystallization gel with the one or more food stuff of the food product and the sweetener component, and at the same time forming small pieces of the anti-crystallization gel.

The warming device may be for instance a process heating comprising flange heating. Flange heaters are those designed for use in various tanks or pressurized vessels, heating both gasses and liquids as needed, and they're commonly used in many food heating applications for keeping an accurate temperature throughout food production. They're also a big help for sterilizing liquids, which limits the risk of contamination that's always a big stress point for restaurant operators. In addition, screw plug heaters are often used in the food and beverage industry. This involves an electric heater that can heat various liquids in small spaces, helping them maintain temperature even under corrosive conditions. The main quality both these products provide is uniform temperature at all times, even when transferring heat in and out of sealed containers.

The most-common styles of industrial mixing equipment are High-Shear Mixers—disperse one ingredient into a main, continuous ingredient (liquid) which typically would be immiscible. A rotor and stator, or an arrangement of rotors and stators, is used either in a tank holding the solution or in a pipe where the solution would pass through to create shear. Batch High-Shear Mixers—ingredients to be mixed are fed from the top into a mixing vessel. These are typically used when larger volume and quicker processing is required. Inline High-Shear Mixers—the rotor-stator arrangement is contained in a housing with an intake at one end and discharge at the other. Ingredients are drawn through a pump array in a continuous stream. They offer a more-controlled mixing atmosphere, require less floor space, and can be part of a continuous process.

The present invention further relates to a use of supramolecular assemblies for reducing formation of sugar alcohol crystals in a food product, the food product comprises one or more food stuff and sugar alcohol.

Preferably, the one or more supramolecular assemblies comprises a plurality of supramolecular assemblies.

### Example 1 (Comparative)

A sweetener composition was produced such that 100 g water and 39 g erythritol was mixed at a temperature of 20° C. Erythritol was dissolved in the water by mixing the water comprising erythritol. After a while the sweetener composition comprises crystals of erythritol.

The crystals of erythritol caused an unpleasant after taste.

### Example 2 (Comparative)

A sweetener composition was produced such that 100 g water and 20g erythritol was mixed at a temperature of 20° C. Erythritol was dissolved in the water. The composition was stored at a temperature of 4° C. After 8 hours at a temperature of 4° C. the sweetener composition comprises crystals of erythritol.

The crystals of erythritol caused an unpleasant after taste.

### Example 3 (Comparative)

A sweetener composition was produced so that 100 g water and xylitol was mixed at a temperature of 20° C. such that the concentration of a xylitol exceeds by 10% the concentration specified by the value of solubility at equilibrium at a temperature of 20° C. Xylitol was dissolved in the water. The composition was stored at a temperature of 4° C. After 24 hours the sweetener composition comprises crystals of xylitol.

The crystals of xylitol caused an unpleasant after taste.

### Example 4 (According to the Present Invention)

A sweetener composition was produced so that 10 g xanthan, 100 g water and erythritol was mixed at a temperature of 25° C. such that the concentration of erythritol exceeds by 10% the concentration specified by the value of solubility at equilibrium. Erythritol was dissolved in the water. The composition was stored at a temperature of 4° C.

After 8 hours the crystals of erythritol was not formed but the sweetener composition was in form of gel. The crystals of erythritol did not cause an unpleasant after taste.

According to this example xanthan prevents or at least decreases crystallization of sugar alcohols but the state of the composition comprising xanthan is gel. In this example the sweetener composition comprises a liquid component, the liquid component being water.

### Example 5 (Comparative)

A sweetener composition was produced such that 0.5 g Lecithin, 100 g water and erythritol was mixed at a temperature of 20° C. such that the concentration of erythritol exceeds by 10% the concentration specified by the value of solubility at equilibrium. Erythritol was dissolved in the water. The composition was stored at a temperature of 4° C.

After 24 hours the crystals of erythritol formed. The crystals of erythritol caused an unpleasant after taste.

### Example 6 (According to the Invention)

A food product was produced such that an anti-crystallization composition was made of 30 g lecithin and 100 g water and a sweetener composition was made of 55 g erythritol and 100 g water. The sweetener composition erythritol was warmed to a temperature of 18° C. 30 g of the anti-crystallization composition and the warmed sweetener composition was mixed.

After 24 hours the crystals of erythritol was not formed but the sweetener composition was not transparent.

### Example 7 (Comparative)

A food product was produced such that 8 g lecithin, 100 g water and erythritol was added to the water at a temperature of 20° C. such that the concentration of a erythritol exceeds by 10% the concentration specified by the value of solubility at equilibrium. Erythritol cooled down the water. Erythritol and lecithin was not dissolved in the water. This example shows that warming is required to provide composition which may be cooled.

This example was repeated by replacing lecithin with mono and diglycerides, quillaja extract, Sodium Stearoyl Lactylate, cellulose gum, carboxy methyl cellulose, sucrose esters of fatty acids, Propylene Glycol Monostearate, Polyglycerol Polyricinoleate, carrageenan and gum karaya and as the result the crystals of erythritol was not formed.

### Example 8 (Comparative)

A food product was produced such that 8 g lecithin, 100 g water and erythritol was added to the water at a temperature of 20° C. such that the concentration of a erythritol exceeds by 10% the concentration specified by the value of solubility at equilibrium. Erythritol cooled down the water. Erythritol and lecithin was not dissolved in the water. The inventor surprisingly found out a warming is required to provide dissolved lecithin and erythritol which may be cooled after the warming.

### Example 9 (According to the Invention)

A food product was produced such that a sweetener composition was formed so that 20 g erythritol was added to 80 g water and then warmed to a temperature of 30° C. An anti-crystallization composition was formed so that 6.5 g baking soda (Sodium Bicarbonate) and 6 g Citric acid was added to 20 g water. The sweetener composition and the anti-crystallization composition was mixed together and cooled down to 4° C. After 24 hours there was no crystals.

### Example 10 (According to the Invention)

A food product was produced such that a sweetener composition was formed so that 40 g erythritol was added to 80 g water and then warmed to a temperature of 30° C. An anti-crystallization composition was formed so that 6.5 g baking soda (Sodium Bicarbonate) and 6 g Citric acid was added to 20 g water. The sweetener composition and the anti-crystallization composition was mixed together. After 24 hours there was no crystals.

### Example 11 (According to the Invention)

A food product was produced such that a sweetener composition was formed so that 40 g erythritol was added to 80 g water. An anti-crystallization composition was formed so that 6.5 g baking soda (Sodium Bicarbonate) and 6 g Citric acid was added to 20 g water. The sweetener composition and the anti-crystallization composition was mixed together and then warmed to a temperature of 30° C. and finally cooled down to 20° C. After 24 hours there was no crystals.

### Example 12 (According to the Invention)

A food product was produced such that a sweetener composition was formed so that 48 g erythritol was added to 80 g water. An anti-crystallization composition was formed so that 13 g baking soda (Sodium Bicarbonate) and 12 g Citric acid was added to 20 g water. The sweetener composition and the anti-crystallization composition was mixed together and then warmed to a temperature of 30° C. and finally cooled down to 20° C. After 24 hours there was no crystals.

### Example 13 (Comparative)

A food product (ice cream) was produced such that 240 g milk, 100 g sugar, 480 g cream and 5 g vanilla extract were mixed in an ice cream mixer and the mixture was frozen at a temperature of −18° C. The frozen food product (ice cream) had a sweet taste without an unpleasant after taste.

### Example 14 (Comparative)

A food product (ice cream) was produced such that 240 g milk, 100 g xylitol, 480 g cream and 5 g vanilla extract were mixed in an ice cream mixer and the composition was frozen at a temperature of −18° C. The frozen food product (ice cream) had an unpleasant after taste.

### Example 15 (Comparative)

A food product (ice cream) was produced such that 240 g milk, 135 g erythritol, 480 g cream, and 5 g vanilla extract were mixed in an ice cream mixer and the composition was frozen at a temperature of −18° C.

The frozen food product (ice cream) had an unpleasant after taste.

### Example 16 (Comparative)

A food product (ice cream) was produced such that 240 g milk, 50 g xylitol, 480 g cream, and 5 g vanilla extract were mixed in an ice cream mixer. Together the milk and the cream comprise 480 g liquid (water). The composition was frozen at a temperature of −18° C.

The frozen food product (ice cream) was not sweet enough.

### Example 17 (According to the Present Invention)

A food product (ice cream) was produced such that 100 g xylitol, 480 g water (in ingredients) and12 g lecithin (powder) were mixed and warmed to 30° C.

The mixture was use to produce ice cream and the composition was frozen.

The frozen food product (ice cream) had a sweet taste without an unpleasant after taste. The inventor surprisingly found out that lecithin may be used as an anti-crystallizing component so that xylitol does not form such an amount of crystals which causes an unpleasant aftertaste in frozen desserts. In this example the sweetener composition comprises a liquid component, the liquid component being water of the milk and the cream. The inventor found out that the sweetener composition comprises supramolecular assemblies comprising lecithin. Furthermore, the sweetener composition comprises molecules of the sweetener component being surrounded by the supramolecular assemblies The inventor surprisingly found out that supramolecular assemblies of the anti-crystallizing component did not compromise a sweet taste of the sweetener component.

### Example 18 (According to the Present Invention)

A food product (ice cream) according to example 17 was produced such that lecithin was replaced with egg yolk at a temperature of 20° C.

### Example 19 (According to the Present Invention)

A food product (ice cream) was produced such that 240 g milk, 100 g xylitol, 480 g cream, lecithin from 40 g egg yolk and 5 g vanilla extract were mixed in an ice cream mixer and the composition was frozen. Together the milk and the cream comprise 480 g liquid (water). The composition was frozen at a temperature of −18° C. in a cartoon packing and the cartoon packing was stored at a temperature of −18° C. for six mounts. A structure of the food product in cartoon packing was compared with a structure of the food product without cartoon packing. The inventor surprisingly found out that a packing further prevents crystallization of xylitol in the frozen food product. This means that the food product has less crystals of xylitol and better taste when it is stored in a cartoon packing. In this example the sweetener composition comprises a liquid component, the liquid component being water of the milk, the cream and the egg yolk.

The inventor repeated this example such that xylitol was replaced with erythritol. The inventor found out that the food product has less crystals of erythritol and better taste when the food product is stored in packing.

The inventor repeated this example such that sweetener component was xylitol and cartoon packing was replaced with a glass and plastic packing. The inventor found out that the food product has less crystals of erythritol and better taste when the food product was packed in any packing. The taste was better when the food product was stored in a cartoon packing than stored in glass and plastic packing.

### Example 20 (Comparative)

A food product (beverage) was produced such that 100 g water, 10 g sugar, and 4% natural lemon and lime flavourings were mixed. The composition was cooled and stored at a temperature of 4° C.

The food product (beverage) had a sweet taste without an unpleasant after taste.

### Example 21 (Comparative)

A food product (beverage) was produced such that 100 g water, 20 g erythritol, and 4% natural lemon and lime flavourings were mixed. The composition was cooled and stored 6 months at a temperature of 4° C.

The food product (beverage) had a sweet taste and an unpleasant after taste.

### Example 22 (Comparative)

A food product (beverage) was produced such that 100 g water, 15 g erythritol, and 4% natural lemon and lime flavourings were mixed. The composition was cooled and stored 10 month at a temperature of 4° C.

The food product (beverage) had a sweet taste. After 6 month the food product comprised precipitate comprising xylitol. The precipitate caused an unpleasant after taste. Most of the beverages can not be mixed after production as they comprise carbon dioxide. Thus, xylitol as such is not suitable sweetener for all typical beverages.

### Example 23 (Comparative)

A food product (beverage) was produced such that 100 g water, 20 g erythritol, and 4% natural lemon and lime flavourings were mixed. The composition was cooled and stored one week at a temperature of 1° C.

The food product (beverage) had a sweet taste but an unpleasant after taste. Thus, erythritol as such is not suitable sweetener for all typical beverages.

### Example 24 (According to the Present Invention)

A food product (beverage) was produced such that 100 g water, 20 g erythritol, 2.6 g baking soda and 4 g natural lemon and lime flavourings were mixed and warmed to 27° C. The composition was then cooled and stored one week at a temperature of 1° C.

The food product had supramolecular assemblies of ionic compounds. The food product (beverage) had a sweet taste without an unpleasant after taste. Furthermore, the colour of the beverage was not changed.

### Example 25 (Comparative)

A food product (beverage) was produced such that 100 g water, 20 g erythritol, 2.6 g baking soda and 4 g natural lemon and lime flavourings were mixed without warming. The composition was then cooled and stored one week at a temperature of 1° C.

The food product had supramolecular assemblies of ionic compounds. The food product (beverage) had crystals of erythritol and an unpleasant after taste.

### Example 25 (According to the Present Invention)

A food product was produced so that 100 g milk, 55 g erythritol and 2 g gelatine were mixed. The composition was warmed to a temperature of 100° C.

The food product had only a little amount of crystals, a sweet taste without a remarkable after taste. A gel was formed.

### Example 26 (According to the Present Invention)

A food product was produced so that 100 g water, 55 g erythritol and 2 g gelatine were mixed. The composition was warmed to a temperature of 100° C.

The food product had only a little amount of crystals, a sweet taste without a remarkable after taste. A gel was formed.

### Example 27 (According to the Present Invention)

A food product was produced so that 100 g milk, 55 g erythritol and 4 g gelatine were mixed. The composition was warmed to a temperature of 100° C.

The food product had no crystals of erythritol and a sweet taste was without any after taste. A gel was formed.

### Example 28 (According to the Present Invention)

A food product was produced so that 100 g water, 55 g erythritol and 4 g gelatine were mixed. The composition was warmed to a temperature of 100° C.

The food product had no crystals of erythritol and a sweet taste was without any after taste. A gel was formed.

### Example 29 (According to the Present Invention)

A food product was produced so that 100 g milk, 55 g erythritol and 1 g gelatine were mixed. The composition was warmed to a temperature of 100° C.

The food product had some of crystals and a sweet taste with a cool after taste. A gel was formed.

### Example 30 (According to the Present Invention)

A food product was produced so that 100 g water, 55 g erythritol and 1 g gelatine were mixed. The composition was warmed to a temperature of 100° C.

The food product had some of crystals and a sweet taste with a cool after taste. A gel was formed.

### Example 31 (According to the Present Invention)

An ice cream was formed so that first 80 g a gel according to the example 25 was produced and it was mixed with 200 g cream and 30 g milk powder. The above mixture was mixed in a blender 3 min time and put in a ice cream device. The ice crem had only little crystals of sugar alcohol and the taste was reasonable.

### Example 32 (According to the Present Invention)

An ice cream was formed so that first 80 g a gel according to the example 25 was produced and it was mixed with 200 g cream and 30 g milk powder. The above mixture was kept cool and mixed in a blender 1 min time and put in a ice cream device. The ice crem had less crystals of sugar alcohol than in an ice cream according to the example 31.

### Example 33 (According to the Present Invention)

An ice cream was formed so that first 80 g a gel according to the example 28 was produced and it was mixed with 200 g cream and 30 g milk powder. The above mixture was mixed in a blender 1 min time and put in an ice cream device. The ice crem had no crystals of sugar alcohol.

### Example 34 (According to the Present Invention)

Examples 3 and 4 were repeated such that the sweetener composition comprises xylitol and a liquid component, and erythritol xylitol and a liquid component. The sweetener composition was tasted when the sweetener composition comprises 1 wt-%, 0.5 wt-%, 0.1 wt-% and 0.01 wt-% crystals of sweetener component based on weight of the sweetener component.

The inventor found out that the sweetener composition which comprises 1 wt % crystals of the sweetener component based on a weight of the sweetener component had a little aftertaste.

The inventor found out that the sweetener composition which comprises 0.5 wt % crystals of the sweetener component based on a weight of the sweetener component had a very little after taste.

The inventor found out that the sweetener composition which comprises 0.1 wt % crystals of the sweetener component based on a weight of the sweetener component had extremely little after taste.

The inventor found out that the sweetener composition which comprises 0.01 wt % crystals of the sweetener component based on a weight of the sweetener component had no after taste.

### Example 35 (According to the Present Invention)

Example 3 was repeated such that the sweetener composition comprises a liquid component and a concentration of the sweetener component in the liquid component exceeding the value of solubility at equilibrium in the liquid component at a temperature of 20° C. by 3 wt-%, by 5 wt-%, by 10 wt-%, by 20 wt-%, by 50 wt-%, by 70 wt-% and by 80 wt-% based on weight of the sweetener component at equilibrium at a temperature of 20° C.,

The inventor found out that the sweetener composition as a syrup was not sweet enough for sweetening most food products when a concentration of the sweetener component in the liquid component exceeding the value of solubility at equilibrium by 3 wt-%.

The inventor found out that the sweetener composition was useful for sweetening a dessert when a concentration of the sweetener component in the liquid component exceeding the value of solubility at equilibrium by 5 wt-% or more.

The inventor found out that the sweetener composition was perfect for sweetening most desserts when a concentration of the sweetener component in the liquid component exceeding the value of solubility at equilibrium by 10 wt-% or more.

The inventor found out that the sweetener composition was good for sweetening many desserts when a concentration of the sweetener component in the liquid component exceeding the value of solubility at equilibrium by 20 wt-% or more.

The inventor found out that the sweetener composition was viscosity of sweetener composition was perfect for most desserts when a concentration of the sweetener component in the liquid component exceeding the value of solubility at equilibrium by 20 wt-% or less.

The inventor found out that the sweetener composition was viscosity of sweetener composition was good for most desserts when a concentration of the sweetener component in the liquid component exceeding the value of solubility at equilibrium by 50 wt-% or less.

The inventor found out that the sweetener composition was viscosity of sweetener composition was good for some desserts when a concentration of the sweetener component in the liquid component exceeding the value of solubility at equilibrium by 70 wt-% or less.

The inventor found out that the sweetener composition was viscosity of sweetener composition was too high for some desserts when a concentration of the sweetener component in the liquid component exceeding the value of solubility at equilibrium by 80 wt-%.

Example 20 was repeated such that the sweetener composition comprises a liquid component and a concentration of the sweetener component in the liquid component exceeding the value of solubility at equilibrium in the liquid component at a temperature of 4° C. by 3 wt-%, by 5 wt-%, by 10 wt-%, by 20 wt-%, by 50 wt-%, by 70 wt-% and by 80 wt-% based on weight of the sweetener component at equilibrium at a temperature of 20° C.,

The inventor found out that the sweetener composition for beverage was not sweet enough for sweetening most beverages when a concentration of the sweetener component in the liquid component exceeding the value of solubility at equilibrium by 3 wt-%.

The inventor found out that the sweetener composition was useful for sweetening a beverage when a concentration of the sweetener component in the liquid component exceeding the value of solubility at equilibrium by 5 wt-% or more.

The inventor found out that the sweetener composition was perfect for sweetening most beverages when a concentration of the sweetener component in the liquid component exceeding the value of solubility at equilibrium by 10 wt-% or more.

The inventor found out that the sweetener composition was good for sweetening many beverages when a concentration of the sweetener component in the liquid component exceeding the value of solubility at equilibrium by 20 wt-% or more.

The inventor found out that the sweetener composition was viscosity of sweetener composition was perfect for most beverages when a concentration of the sweetener component in the liquid component exceeding the value of solubility at equilibrium by 20 wt-% or less.

The inventor found out that the sweetener composition was viscosity of sweetener composition was good for most beverages when a concentration of the sweetener component when the value of solubility at equilibrium being 50 wt-% or less.

The inventor found out that the sweetener composition was viscosity of sweetener composition was good for some beverages when a concentration of the sweetener component in the liquid component the value of solubility at equilibrium by 70 wt-% or less.

The inventor found out that the sweetener composition was viscosity of sweetener composition was too high for some beverages when a concentration of the sweetener component in the liquid component exceeding the value of solubility at equilibrium by 80 wt-%.

Example 31 was repeated such that the sweetener composition comprises a liquid component and a concentration of the sweetener component in the liquid component exceeding the value of solubility at equilibrium in the liquid component at a temperature of −18° C. by 3 wt-%, by 5 wt-%, by 10 wt-%, by 20 wt-%, by 50 wt-%, by 70 wt-% and by 80 wt-% based on weight of the sweetener component at equilibrium at a temperature of 20° C.,

The inventor found out that the sweetener composition for beverage was not sweet enough for sweetening most ice creams when a concentration of the sweetener component in the liquid component exceeding the value of solubility at equilibrium by 3 wt-%.

The inventor found out that the sweetener composition was useful for sweetening a ice creams when a concentration of the sweetener component in the liquid component exceeding the value of solubility at equilibrium by 5 wt-% or more.

The inventor found out that the sweetener composition was perfect for sweetening most ice creams when a concentration of the sweetener component in the liquid component exceeding the value of solubility at equilibrium by 10 wt-% or more.

The inventor found out that the sweetener composition was good for sweetening many ice creams when a concentration of the sweetener component in the liquid component exceeding the value of solubility at equilibrium by 20 wt-% or more.

The inventor found out that the sweetener composition was viscosity of sweetener composition was perfect for most ice creams when a concentration of the sweetener component in the liquid component exceeding the value of solubility at equilibrium by 20 wt-% or less.

The inventor found out that the sweetener composition was viscosity of sweetener composition was good for most ice creams when a concentration of the sweetener component when the value of solubility at equilibrium being 50 wt-% or less.

The inventor found out that the sweetener composition was viscosity of sweetener composition was good for some ice creams when a concentration of the sweetener component in the liquid component the value of solubility at equilibrium by 70 wt-% or less.

The inventor found out that the sweetener composition was viscosity of sweetener composition was too high for some ice creams when a concentration of the sweetener component in the liquid component exceeding the value of solubility at equilibrium by 80 wt-%.

This example was repeated with different sweetener composition having different ratios of lecithin as the anti-crystallizing component, different ratios of xanthan as the anti-crystallizing component and erythritol as the sweetener component.

When the amount of the anti-crystallizing component being 0.005 times an amount of the sweetener component based on weight of the sweetener composition and the anti-crystallizing component prevents very little crystallisation of the sweetener component.

When the amount of the anti-crystallizing component being 0.01 times an amount of the sweetener component based on weight of the sweetener composition and the anti-crystallizing component prevents a little crystallisation of the sweetener component.

When the amount of the anti-crystallizing component being 0.03 times an amount of the sweetener component based on weight of the sweetener composition and the anti-crystallizing component prevents some crystallisation of the sweetener component.

When the anti-crystallizing component being 0.1 times an amount of the sweetener component based on weight of the sweetener composition and the anti-crystallizing component prevents most crystallisation of the sweetener component.

When the anti-crystallizing component being 0.5 times an amount of the sweetener component based on weight of the sweetener composition and the anti-crystallizing component prevents practically all crystallisation of the sweetener component.

When the anti-crystallizing component being 0.3 times an amount of the sweetener component based on weight of the sweetener composition and the anti-crystallizing component prevents almost all crystallisation of the sweetener component.

When the anti-crystallizing component being 0.7 times an amount of the sweetener component based on weight of the sweetener composition and the anti-crystallizing component prevents practically all crystallisation of the sweetener component but the composition is almost solid.

Example 36 (According to the present invention) The inventor found out that Arabitol, Glycerol, Isomalt, Lactitol, Maltitol, Mannitol, Sorbitol, and hydrogenated starch hydrolysates may be used as a sweetener component.

Anyhow, hydrogenated starch hydrolysates and maltitol has higher glycemic index than xylitol and erythritol. Lactitol, maltitol, mannitol and sorbitol have higher dental acidity than xylitol and erythritol. Arabitol is not yet as widely produced sugar alcohol than xylitol and erythritol.

The invention has been described above with reference to the examples shown in the figures. However, the invention is in no way restricted to the above examples but may vary within the scope of the claims.

1. A sweetener composition, wherein:
the sweetener composition comprises an anti-crystallizing component and a sweetener component,
the sweetener component comprises sugar alcohol, and
the sweetener composition is powder or gel or liquid.

2. The sweetener composition according to claim 1, wherein:
the anti-crystallizing component comprises any combination of the following: an emulsifier, an ionic compound, a surfactant, a precursor of surfactant and a precursor of ionic compound; or
the anti-crystallizing component comprises any combination of the following: an emulsifier, a surfactant, a precursor of surfactant and a precursor of surfactant; or
the anti-crystallizing component comprises an ionic compound,
the anti-crystallizing component comprises amphiphilic molecules or a precursor of amphiphilic molecules; or
the anti-crystallizing component comprises Sodium bicarbonate; or
the anti-crystallizing component consists of Sodium bicarbonate and acid molecules; or
the anti-crystallizing component comprises Sodium bicarbonate and acid molecules; or
the anti-crystallizing component comprises any combination of the following: Sodium salt, Sodium acetate and Sodium bicarbonate and acid molecules.

3. The sweetener composition according to claim 1, wherein:
the sweetener component comprises xylitol or erythritol; or
the sweetener component comprises xylitol and erythritol; or
the sweetener component comprises more than 95 wt-% xylitol based on the total weight of the sweetener component; or
the sweetener component comprises more than 95 wt-% erythritol based on the total weight of the sweetener component; or
the sweetener component consists of xylitol or erythritol; or
the sweetener component consists of xylitol; or
the sweetener component consists of erythritol.

4. A food product, wherein:
the food product comprises one or more foodstuff, an anti-crystallizing component and a sweetener component,
the sweetener component comprises sugar alcohol.

5. The food product according to claim 4, wherein:
the food product is a liquid food product or a paste food product or a solid food product; or
the food product is a liquid food product or a paste food product; or
the food product is a beverage; or
the food product is a beverage, and the food product comprises Carbon dioxide; or
the food product is an ice cream.

6. The food product according to claim 4, wherein:
the food product comprises one or more supramolecular assemblies; or
the food product comprises one or more supramolecular assemblies composed from an emulsifier, a surfactant or an ionic compound; or
the food product comprises one or more clusters, wherein each cluster has a hydrophilic region and a hydrophobic region; or
the food product comprises one or more clusters, wherein each cluster has a hydrophilic region and a hydrophobic region, at least one of the one or more clusters being a micelle or at least one of the one or more clusters being a liposome; or
the food product comprises one or more clusters, at least one of the one or more clusters being a micelle or at least one of the one or more clusters being a liposome; or
the food product comprises one or more molecules of the sweetener component surrounded by supramolecular assemblies.

7. The food product according to claim 4, wherein:
the food product comprises a liquid component, and a concentration of the sweetener component in the liquid component exceeding the value of solubility at equilibrium at a temperature of 20° C. by 5 wt-% or more, or at a temperature of 20° C. by 10 wt-% or more, or at a temperature of 20° C. by 20 wt-% or more, or at a temperature of 20° C. by 5-50 wt-%, or at a temperature of 20° C. by 5-20 wt-%, or at a temperature of 20° C. by 5-70 wt-%; or
the food product comprises a liquid component, and a concentration of the sweetener component in the liquid component exceeding the value of solubility at equilibrium at a temperature of 4° C. by 5 wt-% or more, or at a temperature of 4° C. by 10 wt-% or more, or at a temperature of 4° C. by 20 wt-% or more, or at a temperature of 4° C. by 5-50 wt-%, or at a temperature of 4° C. by 5-20 wt-%, or at a temperature of 4° C. by 5-70 wt-%,
the food product comprises a liquid component, and a concentration of the sweetener component in the liquid component exceeding the value of solubility at equilibrium at a temperature of −18° C. by 5 wt-% or more, or at a temperature of −18° C. by 10 wt-% or more, or at a temperature of −18° C. by 20 wt-% or more, or at a temperature of −18° C. by 5-50 wt-%, or at a temperature of −18° C. by 5-20 wt-%, or at a temperature of −18° C. by 5-70 wt-%, based on weight of the sweetener component at equilibrium; or
the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component; or
the food product comprises a liquid component, and a concentration of the sweetener component in the liquid component exceeding the value of solubility at equilibrium at a temperature of 20° C. by 5 wt-% or more, or at a temperature of 20° C. by 10 wt-% or more, or at a temperature of 20° C. by 20 wt-% or more, or at a temperature of 20° C. by 5-50 wt-%, or at a temperature of 20° C. by 5-20 wt-%, or at a temperature of 20° C. by 5-70 wt-%, and the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component; or
the food product comprises a liquid component, and a concentration of the sweetener component in the liquid component exceeding the value of solubility at equilibrium at a temperature of 4° C. by 5 wt-% or more, or at a temperature of 4° C. by 10 wt-% or more, or at a temperature of 4° C. by 20 wt-% or more, or at a temperature of 4° C. by 5-50 wt-%, or at a temperature of 4° C. by 5-20 wt-%, or at a temperature of 4° C. by 5-70 wt-%, and the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component; or
the food product comprises a liquid component, and a concentration of the sweetener component in the liquid component exceeding the value of solubility at equilibrium at a temperature of −18° C. by 5 wt-% or more, or at a temperature of −18° C. by 10 wt-% or more, or at a temperature of −18° C. by 20 wt-% or more, or at a temperature of −18° C. by 5-50 wt-%, or at a temperature of −18° C. by 5-20 wt-%, or at a temperature of −18° C. by 5-70 wt-%, based on weight of the sweetener component at equilibrium, and the food product comprises less than 1 wt-% or less than 0.5 wt-% or less than 0.1 wt-% or less than 0.01 wt-% or 0.5 wt-%-0.01 wt % or 1 wt-%-0.01 wt % crystal particles of sweetener component based on weight of the sweetener component.

8. The food product according to claim 4, wherein:
an amount of the anti-crystallizing component is between 0.01 to 0.7 times or between 0.03 to 0.3 times or between 0.1 to 0.3 times an amount of the sweetener component based on weight of the sweetener composition and the anti-crystallizing component.

9. The food product according to claim 4, wherein:
the one or more foodstuff comprises any combination of the following: a liquid component comprising water, ethanol, one or more components produced from grain, one or more components produced from milk, one or more components produced from egg, a component comprising fruit, a component comprising vegetable, a component comprising berry and one or more component comprising flavouring agent; or
the one or more foodstuff comprises any combination of the following: water, ethanol, one or more components produced from grain, a component comprising fruit, a component comprising berry and one or more component comprising flavouring agent; or
the one or more foodstuff comprises any combination of the following: water, and one or more component comprising flavouring agent; or
the one or more foodstuff comprises any combination of the following: water, and one or more component comprising flavouring agent, and at least one of the one or more food stuff being acid.

10. The food product according to claim 4, wherein:
the food product comprises sweetener, wherein:
the sweetener composition comprises an anti-crystallizing component and a sweetener component,
the sweetener component comprises sugar alcohol, and
the sweetener composition is powder or gel or liquid.

11. A method for producing a food product, wherein the method comprises:
providing one or more food stuff, a sweetener component and an anti-crystallization component, the sweetener component comprising sugar alcohol; and
forming the food product from the one or more food stuff, the sweetener component and the anti-crystallization component.

12. The method according to claim 11, wherein:
the method comprises forming one or more supramolecular assemblies from the anti-crystallization component; or
the method is carried out with an apparatus comprising a warming device, and the method comprises warming with the warming device any combination of the following: the sweetener component, the anti-crystallization component, the food product, the one or more food stuff and the one or more of the food stuff comprising a liquid; or
the method is carried out with an apparatus comprising a warming device and a mixing device, the method comprises warming with the warming device any combination of the following: the sweetener component, the anti-crystallization component, the food product, the one or more food stuff and the one or more of the food stuff comprising a liquid, and mixing with the mixing device any combination of the following: the sweetener component, the anti-crystallization component, the food product, the one or more food stuff and the one or more of the food stuff comprising a liquid; or
the method is carried out with an apparatus comprising a warming device and a mixing device, the method comprises warming with the warming device any combination of the following: the sweetener component, the anti-crystallization component, the food product, the one or more food stuff and the one or more of the food stuff comprising a liquid, and mixing with the mixing device any combination of the following: the sweetener component, the anti-crystallization component, the food product, the one or more food stuff and the one or more of the food stuff comprising a liquid, and increasing a temperature of liquid comprising any combination of the following: the anti-crystallization component, the sweetener component and the food product; or
the method is carried out with an apparatus comprising a warming device and a mixing device, and at least one of the one or more food stuff comprises liquid, and the method comprises mixing at least a portion of the one or more food stuff comprises liquid and the sweetener component together with the mixing device and after mixing one or more food stuff comprises liquid and the sweetener component together, the method comprises a step of warming the mixed liquid and the sweetener component with the warming device; or
the method is carried out with an apparatus comprising a warming device and a mixing device, and at least one of the one or more food stuff comprises water, and the method comprises mixing at least a portion of the one or more food stuff comprises water and the sweetener component together with the mixing device and after mixing one or more food stuff comprises water and the sweetener component together the method comprises a step of warming the mixed water and the sweetener component with the warming device; or
the method is carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid sweetener composition or the liquid anti-crystallization composition with the warming device and, mixing the liquid anti-crystallization composition and the liquid sweetener composition together with the mixing device; or
the method is carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid sweetener composition with the warming device and, mixing the liquid anti-crystallization composition and the liquid sweetener composition together with the mixing device; or
the method is carried out with an apparatus comprising a warming device and a mixing device, one or more food stuff comprises water, and the method comprises a steps of mixing with the mixing device 5-50% of the one or more food stuff comprising water and the anti-crystallization component together for providing a liquid anti-crystallization composition, mixing with the mixing device at least a portion of the remaining of the one or more food stuff comprising water and the sweetener component together for providing a liquid sweetener composition, warming the liquid anti-crystallization composition with the warming device and, mixing the liquid anti-crystallization composition and the liquid sweetener composition together with the mixing device; or
the method is carried out with an apparatus comprising a warming device and a mixing device, one or more food stuff comprises water, and the method comprises a steps of mixing the one or more food stuff comprising water, the anti-crystallization component and the sweetener component together for providing a liquid composition, warming the liquid composition comprising the one or more food stuff comprising water, the anti-crystallization component and the sweetener component with the warming device.

13. The method according to claim 11, wherein:
the sweetener component is a sweetener composition, wherein:
the sweetener composition comprises an anti-crystallizing component and a sweetener component,
the sweetener component comprises sugar alcohol, and
the sweetener composition is powder or gel or liquid.

14.-15. (canceled)
